(19) United States
(12) Patent Application Publication
(10) Pub. No.: US 2014/0074899 A1
(43) Pub. Date: Mar. 13, 2014

(54) METHODS AND SYSTEM FOR EFFICIENT LIFECYCLE MANAGEMENT OF STORAGE CONTROLLER

(71) Applicants: Ben Zion Halevy, Tel-Aviv (IL); Amit GOLANDER, Tel-Aviv (IL)

(72) Inventors: Ben Zion Halevy, Tel-Aviv (IL); Amit GOLANDER, Tel-Aviv (IL)

(21) Appl. No.: 13/781,170

(22) Filed: Feb. 28, 2013

Related U.S. Application Data
(60) Provisional application No. 61/604,017, filed on Feb. 28, 2012.

(51) Int. Cl. G06F 17/30

(52) U.S. Cl. CPC G06F 17/30203
USPC 707/827

(57) ABSTRACT

A computerized method for efficient retirement process of an old controller in a computer network storage system. The method provides for combining legacy non-pNFS data storage with a new temporary parallel NFS data storage. In an embodiment, the method comprises a series of relatively short time consuming operations wherein a storage system efficiently migrates the stored data from the old controller storing legacy data stored solely under pNFS storage, wherein the efficient data migration implements the ability to reclaim layouts (pNFS, stand alone pNFS MDS) and redirect the old data to new controllers. In another embodiment the method comprises a sequence of operations under which a storage system efficiently migrates data from a storage controller that has non-pNFS data storage. In this embodiment the storage utilization during the retirement period combines both legacy non-pNFS storage, as well as new temporary pNFS storage space management.

### CROSS REFERENCE TO RELATED APPLICATIONS

This application claims the benefit of U.S. provisional patent application No. 61/604,017 filed on 28 Feb. 2012 and incorporated by reference as if set forth herein.

### FIELD AND BACKGROUND OF THE INVENTION

The present invention, in some embodiments thereof, relates to computer storage data access and management advanced solutions and, more particularly, but not exclusively, to methods and system for efficient storage controller lifecycle management while implementing out of band pNFS protocol based solutions, wherein the legacy filers in the organization are used as data servers that can mix pre-pNFS data and post-pNFS data files on a single data server, to improve the downtime period usage efficiency of data servers, that need to be retired and replaced.

High-performance data centers have been aggressively moving toward parallel technologies like clustered computing and multi-core processors. While this increased use of parallelism overcomes the vast majority of computational bottlenecks, it shifts the performance bottlenecks to the storage I/O system. To ensure that compute clusters deliver the maximum performance, storage systems must be optimized for parallelism. The industry standard Network Attached Storage (NAS) architecture has serious performance bottlenecks and management challenges when implemented in conjunction with large scale, high performance compute clusters. Parallel storage takes a very different approach by allowing compute clients to read and write directly to the storage, entirely eliminating filer head bottlenecks and allowing single file system capacity and performance to scale linearly to extreme levels by using proprietary protocols.

During the recent years, the storage input and/or output (I/O) bandwidth requirements of clients have been rapidly outstripping the ability of Network File Servers to supply them. This problem is being encountered in installations running according to Network File System (NFS) protocol. Traditional NFS architecture consists of a filer head placed in front of disk drives and exporting a file system via NFS. Under a typical NFS architecture, when a client attempts to access a file the situation is becoming complicated when a large number of clients want to access the data simultaneously, or if the data set grows too large. The NFS server then quickly becomes the bottleneck and significantly impacts the system performance since the NFS server sits in the data path between the client computer and the physical storage devices.

In order to overcome this problem, parallel NFS (pNFS) protocol and related system storage management architecture has been developed. pNFS protocol and its supporting architecture allows clients to access storage devices directly and in parallel. The pNFS architecture increases scalability and performance compared to former NFS architectures. This increment is achieved by the separation of data and metadata and using a metadata server out of the data path.

In use, a pNFS client initiates data control requests on the metadata server, and subsequently and simultaneously invokes multiple data access requests on the cluster of data servers. Unlike in a conventional NFS environment, in which the data control requests and the data access requests are handled by a single NFS storage server, the pNFS configuration supports as many data servers as necessary to serve client requests. Thus, the pNFS configuration can be used to greatly enhance the scalability of a conventional NFS storage system. The protocol specifications for the pNFS can be found at URL: www.itef.org, see NFS4.1 standards, at the URL: www.open-pNFS.org and the www.itef.org Requests for Comments (RFC) 5661-5664 which include features retained from the base protocol and protocol extensions. (RFC) 5661-5664 which includes major extensions such as; sessions, directory delegations, external data representation standard (XDR) description, a specification of a block based layout type definition to be used with the NFSv4.1 protocol, and an object based layout type definition to be used with the NFSv4.1 protocol.

Retiring a shared NFS storage controller, especially but not solely important while upgrading a computer storage system to a pNFS environment, takes months in many production/operational environments. Shutting down a controller requires the migrating of the stored data and updating all clients' applications accordingly. This process takes a considerable amount of time, due to the following reasons:
1. While controllers are well aware of the data they hold, they are ignorant of the client applications currently using that data, or that may use it eventually in another time.
2. In a case when the administrator is aware of using an application, it takes time to synchronize and agree on the down time slot for it.

The above storage controller long down-time requirement process is true for both Storage Area Network (SAN) and for the Networked Attached Storage (NAS) controllers, also called Array (SAN) or Filer (NAS).

There are several methods of overcoming the substantially long controller's down-time process limitation. One such an exemplary known solution is based on the following method;

Once the administrator identifies a relevant application and its data, the following steps are implemented:
a. A down time window is scheduled for the application;
b. The data is copied from the old about-to-be-retired controller to new a controller/s. This can be done prior to the down-time in specific scenarios in which the old and new controllers support the same proprietary synchronous mirroring protocol; and
c. The application is brought down, its storage is reconfigured and then it reboots. That said, applications running on advanced virtual infrastructures, may be migrated to another cluster using a different storage, while preserving the system operational continuity.

This process repeats per all identified applications using the about-to-be-retired controller. When the administrators think that they are done, they usually monitor the I/O data traffic on the about-to-be-retired controller to see if there are active requests. If no activity is visible for a while, the controller is assumed to be vacant.

Some of the known drawbacks of the existing down-time process solutions may be summarized as to the following: a. synchronizing the down time for an application takes a substantial amount of time; and b. there is never a full level of certainty that all client applications are aware of the change in data location. Consequently the old controller is kept alive for months in order to identify as many client applications as possible. Meanwhile the storage controller consumes resources and operates at a very low utilization. FIG. 1 exemplifies an exemplary under-utilized controller that started the retirement process in January and was kept alive for 9 months until finally shut down.

There is thus a need in the art for the cases of pNFS storage systems to shorten the time duration of the retirement period related to old controllers retirement process, or alternatively for the cases of non-pNFS storage systems, to improve the utilization of the about-to-be-retired storage controller within the substantially long period of underutilization time, until it can be shut down, while continuously operating and managing the system operational data processing throughput and performance in its full capacity.

### GLOSSARY

Network File System (NFS)—a distributed file system open standard protocol that allows a user on a client computer to access files over a network, in a manner similar to how local storage is accessed by a user on a client computer.
NFSv4—NFS version 4 includes performance improvements and stronger security. It supports clustered server deployments, including the ability to provide scalable parallel access to files distributed among multiple servers (the pNFS extension).
Parallel NFS (pNFS)—a part of the NFS v4.1 allows compute clients to access storage devices directly and in parallel. pNFS architecture eliminates the scalability and performance issues associated with NFS servers by the separation of data and metadata and moving the metadata server out of the data path.
pNFS Metadata Server (MDS)—is a special server that initiates and manages data control and access requests to a cluster of data servers under the pNFS protocol.
Network File Server—a computer appliance attached to a network that has the primary purpose of providing a location for shared disk access, i.e. shared storage of computer files that can be accessed by the workstations that are attached to the same computer network. A file server is not intended to perform computational tasks, and does not run programs on behalf of its clients. It is designed primarily to enable the storage and retrieval of data while the computation is carried out by the workstations.
External Data Representation (XDR)—a standard data serialization format, for uses such as computer network protocols. It allows data to be transferred between different kinds of computer systems. Converting from the local representation to XDR is called encoding. Converting from XDR to the local representation is called decoding. XDR is implemented as a software library of functions which is portable between different operating systems and is also independent of the transport layer.
Storage Area Network (SAN), (also called Array)—a dedicated network that provides access to consolidated, block level computer data storage. SANs are primarily used to make storage devices, such as disk arrays, accessible to servers so that the devices appear like locally attached devices to the operating system. A SAN typically has its own network of storage devices that are generally not accessible through the local area network by other devices. A SAN does not provide file abstraction, only block-level operations. File systems built on top of SANs that provide file-level access, are known as SAN file systems or shared disk file systems.
Network-attached storage (NAS), (also called Filer)—a file-level computer data storage connected to a computer network providing data access to a heterogeneous group of clients. NAS operates as a file server, specialized for this task either by its hardware, software, or configuration of those elements. NAS is often supplied as a computer appliance, a specialized computer for storing and serving files. NAS is a convenient method of sharing files among multiple computers. Its benefits for network-attached storage, compared to file servers, include faster data access, easier administration, and simple configuration.
NAS systems—networked appliances which contain one or more hard drives, often arranged into logical, redundant storage containers or RAIDs. Network-attached storage removes the responsibility of file serving from other servers on the network. They typically provide access to files using network file sharing protocols such as NFS, SMB/CIFS, or AFP.
Redundant Array of Independent Disks (RAID)—a storage technology that combines multiple disk drive components into a logical unit. Data is distributed across the drives in one of several ways called “RAID levels”, depending on the level of redundancy and performance required. RAID is used as an umbrella term for computer data storage schemes that can divide and replicate data among multiple physical drives. RAID is an example of storage virtualization and the array can be accessed by the operating system as one single drive.
Logical Unit Number (LUN)—a LUN can be used to present a larger or smaller view of a disk storage to the server. In the SAN Storage environment, LUNs represent a logical abstraction, or a virtualization layer between the physical disk device/storage volume and the applications. The basic element of storage for the server is referred to as the LUN. Each LUN identifies a specific logical unit, which may be a part of a hard disk drive, an entire hard disk or several hard disks in a storage device. A LUN could reference an entire RAID set, a single disk or partition, or multiple hard disks or partitions. To the logical unit is treated as if it is a single device.
Logical Volume (Volume)—A logical Volume is composed of one or several logical drives, the member logical drives can be the same RAID level or different RAID levels. A logical drive is simply an array of independent physical drives. The logical drive appears to the host the same as a local hard disk drive does. The Logical Volume can be divided into a maximum of 8 partitions. During operation, the host sees a non-partitioned Logical Volume or a partition of a partitioned Logical Volume as one single physical drive.
Client—A term given to the multiple user computers or terminals on the network. The Client logs into the network on the server and is given permissions to use resources on the network. Client computers are normally slower and require permissions on the network, which separates them from server computers.
Layout—a storage area assigned to an application or to a client containing the location of the specific data package in the storage system memory.

### SUMMARY OF THE INVENTION

The following embodiments and aspects thereof are described and illustrated in conjunction with methods and systems, which are meant to be exemplary and illustrative, not limiting in scope. In various embodiments, one or more of the above-described problems have been reduced or eliminated, while other embodiments are directed to other advantageous or improvements.

There is thus a widely-recognized need in the art in the process of retiring a shared NFS storage controller, in one of the present invention embodiments of operating under a pNFS environment, for enabling the substantial shortening of the retirement time period of the about-to-be-retired pNFS storage controller until it can be shut down, while still operating and managing the system data management operational throughput in its full capacity.

It overcomes in one embodiment of the present invention method of operating under a pNFS environment, the limitation of the prior art long period of time of low utilization of the about-to-be-retired storage controller. This can be done by leveraging the virtualization and implementing the pNFS version of the common network file system (NFS) protocol to substantially shorten the time period required for the entire controller retirement period, thus avoiding the present art very long duration under utilization period of the about-to-be-retired storage controller during the downtime period. The drastic shortening of the down time period is supported by relying on two pNFS environment related byproducts: a. the pNFS inherent separation of data and metadata and using a metadata server (MDS) out of the data path; and b. most pNFS layout types (e.g. Block, NFS-obj, flex-files) have the ability to use legacy Filers, or Arrays, as their Data Servers (DSs)

There is thus a widely-recognized need in the art in the process of retiring a shared NFS storage controller, in another present invention embodiment of operating under a non-pNFS environment, especially important while upgrading to a pNFS environment, or under a mixed non-pNFS and a pNFS system environment, for enabling the improved optimal utilization of the about-to-be-retired storage controller during the period of time of the organized retirement of the NFS storage controller until it can be shut down. The present invention another embodiment method will therefore support better maintenance and the optimal operation and management the system's data management operational throughput to its full capacity.

The second embodiment of the present invention method overcomes the limitation of the prior art low utilization of the about-to-be-retired storage controller in a non pNFS system environment. This is done while leveraging the virtualization and by implementing the pNFS version of the common network file system (NFS) protocol to avoid the under utilizing the about-to-be-retired storage controller during the downtime period, relying on two pNFS environment related byproducts: a. the pNFS inherent separation of data and metadata and using a metadata server (MDS) out of the data path; and b. most pNFS layout types (e.g. Block, NFS-obj, flex-files) have the ability to use legacy Filers, or Arrays, as their Data Servers (DSs)

There is thus provided, a computerized method for managing the data objects and layout data stored in an at least one first storage device of a parallel access network system having a meta data server managing the layout data and the transfer of the data objects to at least one second storage device operating under the parallel access network system includes a sequence of steps for optimal storage capacity management and use of the at least one first storage device during the time period associated with the data objects transfer from the at least one first storage device to at least one second storage device, wherein the data associated with the at least one first storage devices is not managed under the meta data server. The method includes the steps of:
defining the desired the storage capacity utilization parameter goal of the at least one first storage device selected from the group of options includes defining the parameter by the system storage administrator and defining the parameter by a system default option;
assigning a new group of layout data related to the at least one first storage device to be loaned or leased to the system meta data server
recalculating the periodic utilization storage capacity of the at least first storage device by measuring the periodic utilization representing the capacity utilization of the at lest one first storage device;
calculating a periodic free space parameter to be assigned to a layout pool managed by the meta data server wherein the storage periodic free space=the storage desired storage utilization−the storage periodic utilization;
adding the storage calculated periodic free space to the assigned size of the group of layouts while resizing the group of layouts;
repeating the sequence of recalculating the first storage devices group periodic utilization storage capacity; and
ending the recalculation process when the system administrator detects that only a non-significant amount of the object data and associated layouts which are not managed under the meta data server associated with the at least one first storage devices is left on the at least one first storage device.

Furthermore the method further includes the step of waiting for a periodic watchdog prior to recalculating the periodic utilization storage capacity of the first storage device.

Furthermore, the method, further includes the step of executing a retirement procedure for the at least one first storage devices at the end of the sequence of steps.

Furthermore the retirement procedure comprises the steps of:
extracting the layouts associated with the at least one first storage devices from their new allocation options to avoid its further usage for the system new applications by any of the plurality of the system clients;
blocking new layout requests for any group of selected layouts associated with the at least one of first storage device;
issuing a layout recall request to a plurality of clients sharing relevant layout copies in the group of selected access data;
waiting for up to a predefined lease time to get from the clients a layout return feedback notice concerning sharing a matching layout;
receiving layout return acknowledges responses from the plurality of clients;
migrating the object data associated with the group of selected layouts from the first storage device to a newly selected plurality of storage devices; and
repeating the sequence of object data transfer steps from the first storage device to the second storage device until all data content of the first storage devices is transferred to at the second storage device.

Furthermore, the parallel access network system having a meta data server is a pNFS network system having a MDS data server.

Furthermore, the first and second storage devices may comprise NAS File level type storage data servers or SAN Block level type storage data servers.

Furthermore, the parallel access network system having a meta data server is a pNFS network system having a MDS data server.

In addition, there is a provided a parallel access network file system, which includes a metadata server storing and managing layout data, a plurality of clients sharing the system, at least one first storage device storing data objects and layouts, at least one second storage device; and wherein the system executes a retirement procedure for the at least one first storage device under a sequence of steps intended for optimal storage capacity management and use of the first storage device during the time period associated with the retirement procedure wherein the data objects are gradually transferred from the plurality of first storage devices to the second storage device, and wherein the data stored in the first storage device is not managed under the meta data server.

Furthermore, the layouts stored in the first storage device are loaned or leased during the procedure to the meta data server storing and managing layout data. The optimal storage capacity management and use of first storage devices is executed the metadata server is using the leased layouts to temporary store in the first storage devices additional leased data objects.

Furthermore, the metadata server is storing the leased data objects so that the sum of the gradually diminishing number of the originally stored data objects on the first storage device with the temporarily leased data objects is kept practically constant while maintaining the plurality of first storage devices data storage capacity to its optimal storage level defined by one of a group including the system administrator and the system default parameter.

Furthermore, the first storage devices may be NAS servers and the stored data objects and layouts may be Blocks and LUNS.

In addition, there is a provided a computer program product for executing a retirement procedure for a plurality of storage devices retirement procedure in a parallel access network file system includes a metadata server storing and managing layout data, a plurality of clients sharing the system, at least one first storage device storing data objects and layouts and at least one second storage device, wherein the retirement procedure for the first storage device storing data objects and layouts is executed under a sequence of steps intended for the optimal storage capacity management of the first storage devices and use during the time period associated with the retirement procedure wherein the data objects are transferred from the first storage devices to the second storage device, and wherein the data stored in the first storage devices is not managed under the meta data server.

The computer program includes first program instructions to define the desired the data storage capacity utilization parameter goal of the first storage device by the system storage administrator; second program instructions to assign a new group of layout data related to the first storage device to be loaned or leased to the system meta data server; third program instructions to wait for a periodic watchdog prior for recalculating the periodic utilization storage capacity of the first storage device; forth program instructions for recalculating the periodic utilization storage capacity of the first storage device by fifth program instructions to measure the Periodic_utilization representing the capacity utilization of plurality of the first storage devices; sixth program instructions to calculate the Periodic_free_space to be assigned to a layout pool managed by the meta data server wherein Periodic_free_space=Desired_utilization−Periodic_utilization; seventh program instructions to add the calculated Periodic_free_space to the assigned size of the group of layouts via a Resize; eighth program instructions to repeat the sequence of recalculating the periodic utilization storage capacity of the first storage device; and ninth program instructions to end the sequence of recalculating the at least one first storage device periodic utilization storage capacity when only a non-significant amount of said object data and associated layouts which are not managed under said meta data server associated with the at least one first storage device are left on said at least one first storage device;

The first, second, third, fourth, fifth, sixth, sevenths and eighths program instructions are stored on the computer readable storage medium.

Furthermore there is provided a computer program product for executing a retirement procedure on at least one of the first plurality storage devices, wherein the program further comprises a tenth program instructions to execute a retirement procedure for the at least one of the first plurality storage devices.

it will be appreciated by persons skilled in the art that though the present invention refers to at least one first storage device and to at least one second storage device, at least one may also apply to a group or plurality of first and second storage devices.

Unless otherwise defined, all technical and/or scientific terms used herein have the same meaning as commonly understood by one of ordinary skill in the art to which the invention pertains. Although methods and systems similar or equivalent to those described herein can be used in the practice or testing of embodiments of the invention, exemplary methods and/or systems are described below. In case of conflict, the patent specification, including definitions, will control. In addition, the materials, methods, systems and examples herein are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIG. 1 is an illustration of an example utilization graph demonstrating controller's utilization in percents, versus time duration, of an exemplary present art legacy non-pNFS, non-virtualized storage system with an under-utilized data controller in the process of retiring by the system administrator.

FIG. 2 is a schematic illustration of a storage system that includes metadata server (MDS) and a plurality of storage devices, also known in pNFS systems environment as data servers, which provide storage services to a plurality of concurrent retrieval clients, according to some embodiments of the present invention;

FIGS. 3A-3E is a schematic flow chart illustration of a state machine wherein states reflect actions and transition arrows relate to internal or external triggers, which are performed with regard to a certain layout, according to one embodiment of the present invention wherein in this state machine is demonstrating migrating legacy data solely under pNFS storage, done through the ability to reclaim layouts (pNFS, stand alone pNFS MDS) and redirect the old data to new controller/s.

FIG. 4 is an illustration of an example utilization graph of an exemplary storage controller in the case of legacy data on pNFS+virtualized storage embodiment of the present invention, wherein migrating legacy data from an under-utilized data controller in the process of retiring by the system administrator is done solely under pNFS storage in a much shorter time period due to the ability to reclaim layouts (pNFS, stand alone pNFS MDS) and redirect the old data (virtualized storage) to new controller/s.

FIGS. 5A-5B is a schematic flow chart illustration of a state machine according to another embodiment of the present invention, wherein migrating data from a storage controller that has data that is not run under pNFS storage may be considered harder, complicated and highly time consuming. In this embodiment the storage utilization during the retirement period combines both legacy non-pNFS, non-virtualized storage, as well as new temporary pNFS storage space use. In this embodiment we may not shorten the period of time in which the controller fades out and retires, but focus on improving the old data controller utilization during the time period that is required for the process of retiring the old controller by the system administrator.

FIG. 6 is an illustration of an example utilization graph of an exemplary another embodiment of the present invention methods, wherein the method is implemented in migrating the legacy data from an under-utilized data controller in the process of retiring by the system administrator and wherein the controller combines during the retirement process both legacy non-pNFS storage space data content, as well as new temporary pNFS storage space. This case may be considered more complicated and time consuming. In this case we may not shorten the period of time in which the controller fades out, but focus on improving the old controller utilization during the downtime period by gradually storing on it more of the temporary pNFS+virtualized data content.

### DETAILED DESCRIPTION OF EMBODIMENTS OF THE INVENTION

The present invention, in some embodiments thereof, relates to access data and, more particularly, but not exclusively, to methods and system of out of band access data management and old data storage controllers retirement.

Before explaining at least one embodiment of the invention in details, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash/SSD memory), an optical fiber, a portable compact disc read-only memory (CD-ROM), an optical storage device, a magnetic storage device, a RAID, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to electronic, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, systems and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

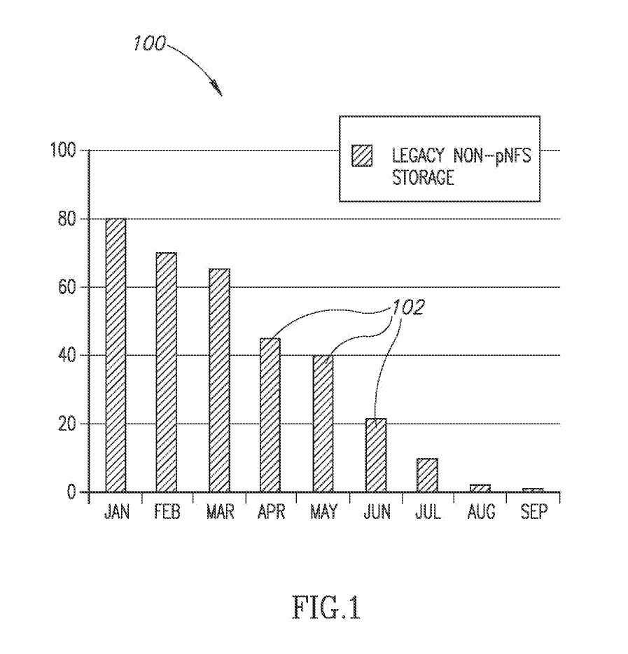

Reference is now made to FIG. 1, which is an illustration of an example of a utilization graph 100 representation of an exemplary legacy NFS storage system with an under-utilized data storage controller, which is in the process of retiring by the system administrator. Under this example the administrator has started the process in January and the data storage controller was kept alive for 9 months, while the data storage capacity and the related utilization percentage of the storage controller, represented by the dark bars 102, is going down in time, until finally the controller is practically empty of stored data and is shut down by the system administrator.

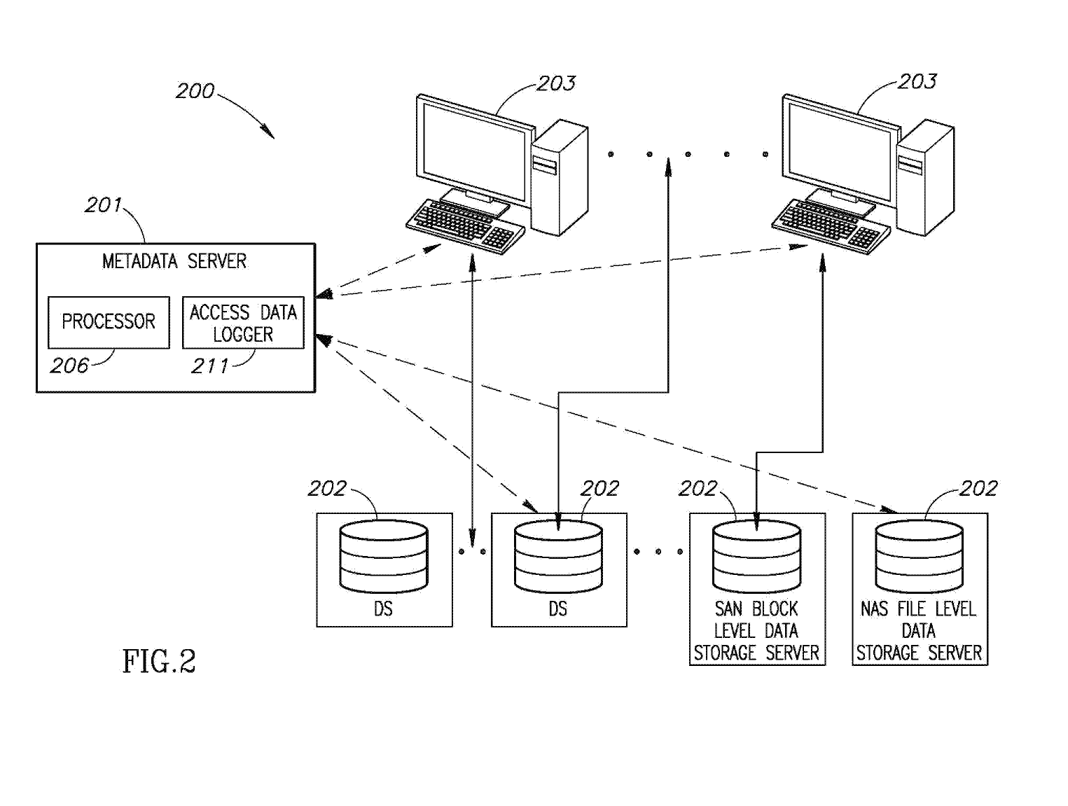

Reference is now made to FIG. 2, which is a schematic illustration of a storage system 200, optionally a concurrent retrieval configuration system 200, such as a pNFS storage system, that includes a metadata server (MDS) 201 and a plurality of storage devices, also known in pNFS as data servers (DS) 202 which provide storage services to a plurality of concurrent retrieval clients 203, according to some embodiments of the present invention. Optionally, the metadata server 201 logs data in access data logger 211, that is indicative of access operations, such as read and/or write operations, in various types of storage devices 202, such as a SAN block level data storage and a NAS file level data storage, according to a protocol such as pNFS protocol. Access data logger 211 may monitor a plurality of layout requests which are received from the clients 203. The metadata server 201 maybe a software based server, or a hardware based server with a processor 206 and wherein one or more of the storage devices 202, for example storage servers, maybe hosted together on a common host. In use, The storage system 200 handles data control requests, for example layout requests, recall requests, layout return requests and the plurality of storage devices 202 process data access requests, for example data writing and retrieving requests.

Optionally, the metadata server 201 includes one or more processors 206, referred to herein as a processor in addition also a memory (e.g. local Flash or SSD memories), communication device(s) (e.g., network interfaces, storage interfaces), and interconnect unit(s) (e.g., buses, peripherals), etc. The processor 206 may include central processing unit(s) (CPUs) and control the operation of the system 200. In certain embodiments, the processor 206 accomplishes this by executing software or firmware stored in the memory. The processor 206 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices. A plurality of metadata servers 201 maybe also be used in parallel. In such an embodiment, the metadata servers 201 are coordinated, for example using a node coordination protocol. For brevity, any number of metadata servers 201 is referred to herein as a metadata server 201.

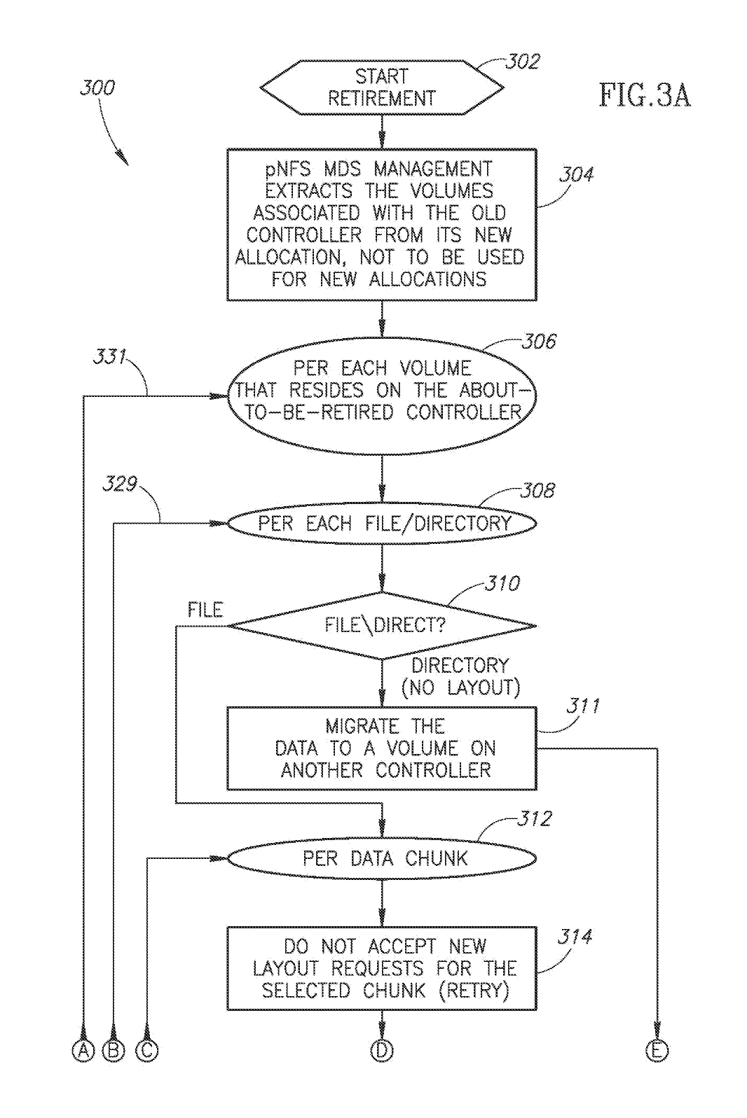

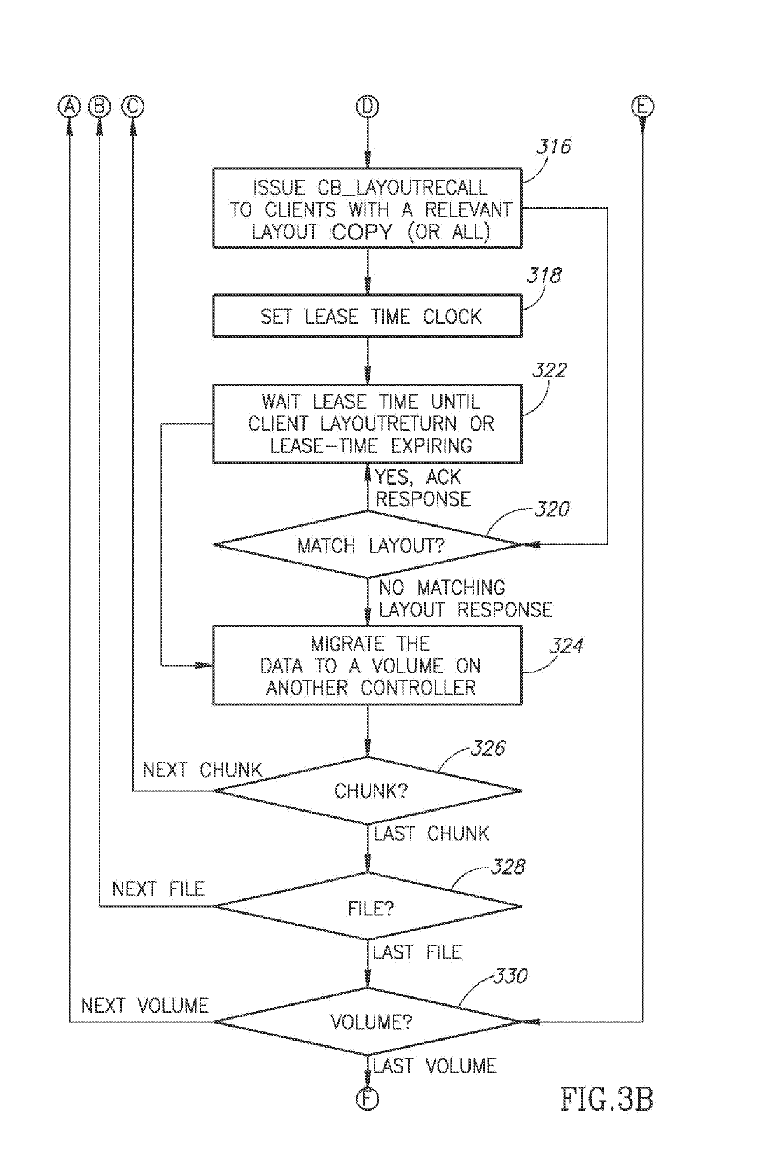

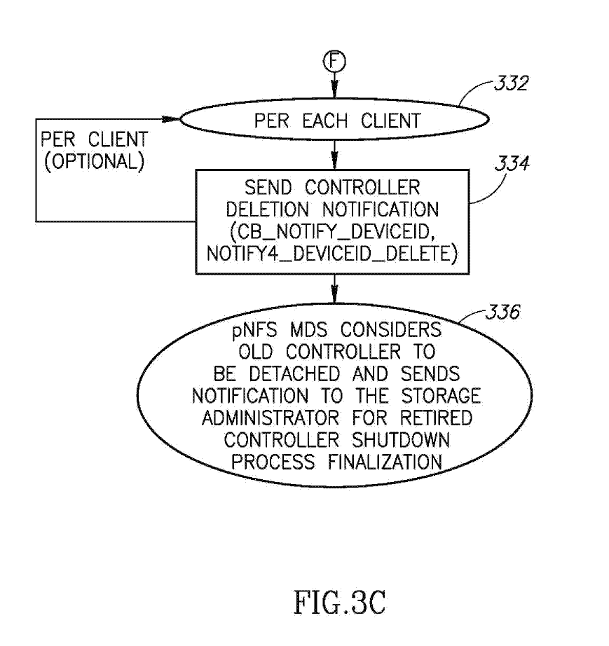

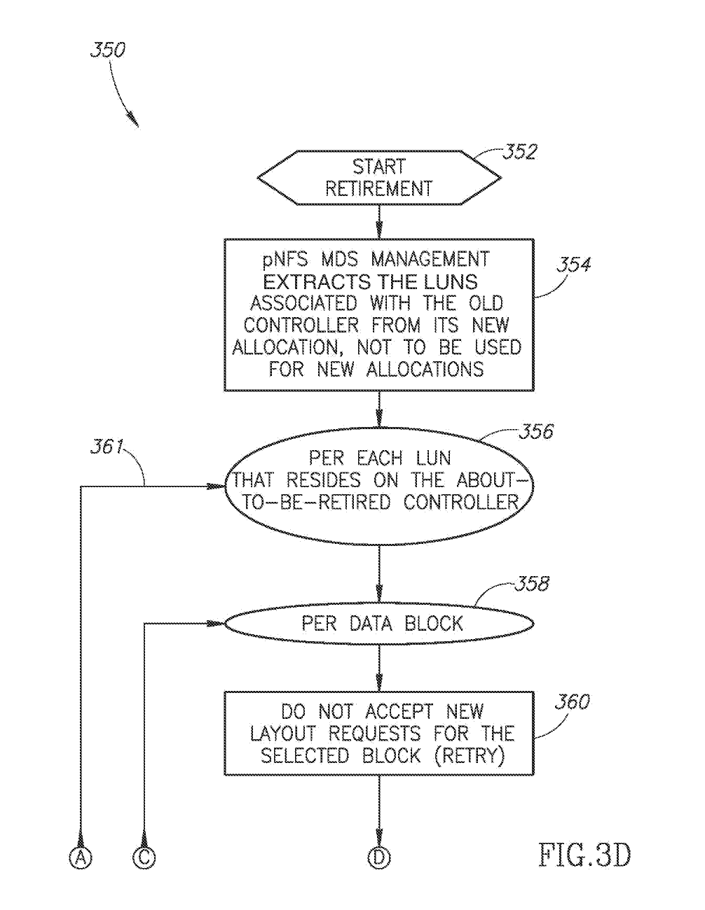

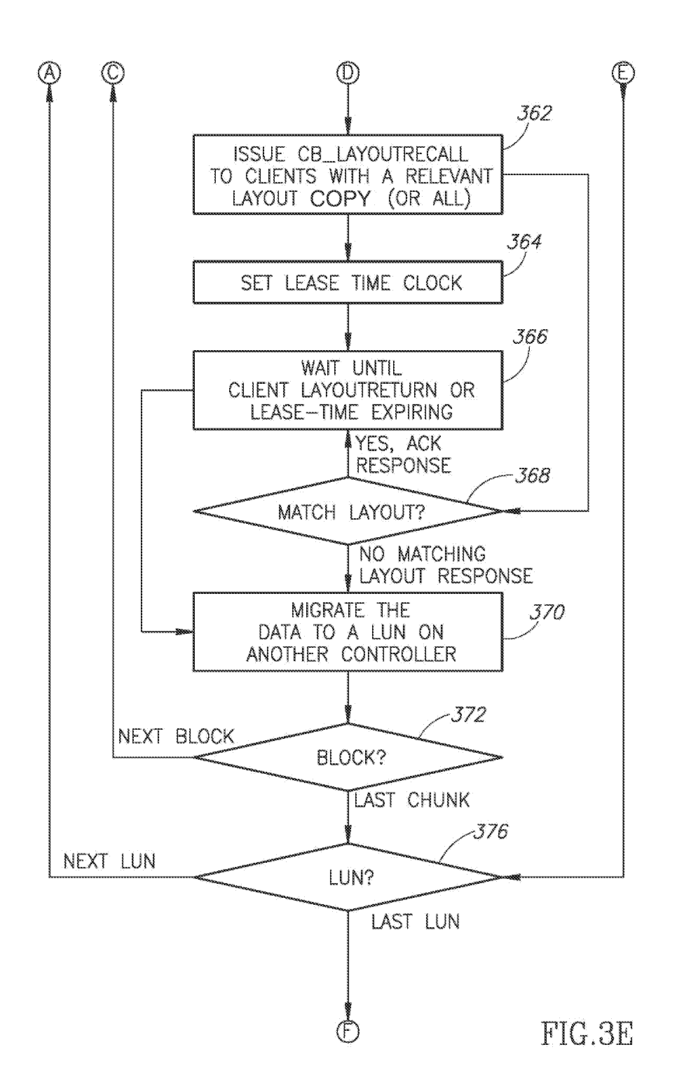

Reference is now made to FIGS. 3A-3E, which is a schematic flow chart illustration of a method running under a flowchart representing a state machine wherein states reflect actions and transition arrows relate to internal or external triggers which are performed with regard to a certain layout, according to one embodiment of the present invention, wherein this state machine is demonstrating migrating legacy data from one system storage controller to another, solely under pNFS storage, done through the ability to reclaim layouts (pNFS, stand alone pNFS MDS) and redirect the old data (virtualized storage) to new controller/s at a sub-file granularity. This state machine that represents the present invention In one possible method embodiment of the invention it is demonstrated that it is possible to perform the entire migration process in a matter of hours or days, compared to the rather very long duration, in the order of months, that present art storage management solutions may require. Also, in the proposed embodiment solution there is no risk of missing rarely used client's applications. FIG. 3 is a flowchart 300 of a state machine describing a method for retiring a storage controller, running solely under pNFS storage of a parallel access network file system, such as the system 200 depicted in FIG. 2, according to some embodiments of the present invention.

In use, referring now to FIGS. 3A. and 3B. when we are dealing with the case on a NAS type server retirement, as shown at flowchart 300, a typical pNFS architecture parallel access storage system 200 administrator, decides at the initial stage 302 to start a retirement process of one of the system data storage controllers (202), typically the retirement is initiated due to the selected controller aging, or due to the retiring controller associated technical operational malfunctioning problems. The first controller retirement method step 304 is associated with the pNFS Meta Data System (MDS) management extracting the Volumes that are associated with the selected storage controller from the MDS new allocation options list, not to be used by the MDS for new file/block/object allocations needs. This will prevent new data from being created on retiring Volumes and the need to relocate it later in the process. Stage 306 is a loop activation stage that is starting an internal process on the retired controller stored data, regarding transferring the data for each of the selected controller Volumes to a newly selected controller allocation for each Volume that resides on the about to be retired controller. Step 308 is an internal second lower level hierarchy sub-loop activation stage that is starting an internal sub-process on the retired controller stored data, regarding transferring the data for each of the selected controller Files to a newly selected controller allocation for each File that resides on the about to be retired controller.

Decision making stage 310 is managing the evaluation step of analyzing the selected file of the about-to-be-retired storage controller data content. Specifically 310 checks if the file at hand is a data file generated by clients (203) or a special file (e.g. Directory) generated by the MDS (201), if such are stored on DSs (202). If this is a File the sequence continues to stage 312 to manage each of the data chunks combining the selected file that was done in stage 308 and if the selected data chunk is a Directory the system migrates the directory data to a selected Volume in a newly selected controller (202) under stage 311. Step 312 is an internal third lower level hierarchy sub-loop activation stage that is starting an internal sub-process on the retired controller stored data, regarding transferring the data for each of the selected controller data chunks to a newly selected controller allocation for each data chunk that resides on the about to be retired controller selected File. After selecting a specific data chunk in a selected File the MDS at step 314 will flag to itself not to accept new layout requests for the selected chunk. As a result, clients (203) that try to get a layout to that particular byte range from step 316 and until step 326 will get a Retry response. The MDS may reduce the duration that a data chunk is denied access by using smaller data chunks. The next step 316 is related to the MDS system sending an instruction to return the layout once given (CB_LAYOUTRECALL). This is sent to clients with a relevant layout copy, which are layout recall messages to all the system clients that have or use layouts in the about to be retired controller, or alternatively the system sends this message to all the system clients. The following step is related to the system itself, or through the system administrator manual instruction to the system, is setting up a lease time clock that defines the maximal time duration that the system will wait for all the addressed clients' response related to the CB_LAYOUTRECALL request issued in step 316.

Decision making step 320 is initiated by the previous step 316 that issued to all the system's clients a request to check if they are using the relevant matching layout. If there is no matching layout feedback response received by the system, then the relevant data chunk selected in step 312 is migrated by the system in step 324 to a new Volume to be stored in one or more newly selected replacement controllers that are selected by the system to replace the old retiring controller. Alternatively if there is a positive acknowledge with a matching layout response coming from a client, then step 322 is initiated which represents executing a waiting delay, created as defined in step 318, generated for waiting for the addressed client feedback response during the lease time generated by the 318 time clock, until a client LAYOUTRETURN is received by the system, or the lease-time waiting time delay is expiring during which no LAYOUTRETURN client's feedback has been received. At this stage step 324 is triggered and the relevant selected chunk of data is removed by the system and extracted from the old controller Volume to a new Volume on another newly selected replacement storage controller. To summarize, the old controller retirement downscaled process represented by the set of steps 314,316,318,322 and 324 represent the entire proposed sequence of steps of transmitting under the present invention method the old controller data to a newly selected replacement storage controller, all related to a selected data chunk in a selected file, residing on a selected Volume that is residing on the retired storage controller.

Step 326 is another decision making stage for checking if there are more relevant data chunks in the retiring controller that need to be migrated to the new controller, if there is another relevant data chunk the system returns to step 312 and starts a new chunk status evaluation process and migration cycle, done by executing another cycle of the steps 314,316,318,322 and 324. This cycle loop is repeated until all the data chunks in the selected file were migrated from the old to be retired controller to the new selected controller. When the last chunk in the selected file was detected and migrated to the newly selected controller, or to a plurality of newly selected controllers, the system then starts to evaluate in the decision step 328 if there is a still new relevant file to be migrated from the retiring storage controller. If yes, a loop feedback indicated under transition arrow trigger 329 additional cycle is initiated wherein the present invention old controller retirement process goes back to step 308 and the migration process starts again for all the chunks included in the next selected for evaluation and the stored data migration file. When all the relevant Files in the Volume selected in stage 306 have been evaluated and their data contents was transferred from the retiring controller to the newly selected storage controller, then the system is moving to decision step 330.

Decision step 330 is checking if there are additional Volumes in the retiring controller to be evaluated for their data content to be transferred from the old retiring controller to the newly selected controller. If there are additional Volumes to be checked for their data content transfer, then a loop action under transition arrow trigger 331 indicating an additional cycle is initiated, where the process returns to 306 to start and repeat again the content evaluation and data transfer process for the entire next evaluated Volume in the about to be retired controller. When all the Volumes in the retired controller have been already evaluated by the system and their data content has been transferred to the newly selects controller the decision step 330 is at this stage indicating the stage wherein the system has ended the selected retiring controller retiring process as stated in the final stage 336. At that stage the pNFS MDS system considers the old retiring controller to be detached and sends notification to the Storage Administrator for retired controller shutdown process finalization.

As an optional system clients' oriented operational safety add-on level to this retirement process method, an optional process loop containing the stages 332 and 334 may be executed. This optional stage is sending the controller deletion notification to each one of the system clients to let them know that the selected retired server is no more under operation and all its Volumes are void of relevant data for their applications. This loop is optional since in any case the MDS server of the pNFS system has all the required updated address data related to the new controller data content and data organization, so that the clients will be able to access directly and with no further interruptions the new related layouts required for their applications that are at this stage all resident in the newly selected and relevant data updated controller.

The above method steps for moving the entire data content and its transfer process from an old to be retired controller to a newly selected controller under the pNFS system management enables a very short and efficient storage controller aging cycle when compared to the present art legacy NFS systems controller's much longer time duration related retirement process.

In use, referring now to FIGS. 3D. and 3E. when we are dealing with the case on a SAN type server retirement, as shown at flowchart 350, a typical pNFS architecture parallel access storage system 200 administrator, decides at the initial stage 352 to start a retirement process of one of the system data storage controllers (202), typically the retirement is initiated due to the selected controller aging, or due to the retiring controller associated technical operational malfunctioning problems. The first controller retirement method step 354 is associated with the pNFS Meta Data System (MDS) management extracting the LUNs that are associated with the selected storage controller from the MDS new allocation options list, not to be used by the MDS for new file/Block/object allocations needs. This will prevent new data from being created on retiring LUNs and the need to relocate it later in the process.

Stage 356 is a loop activation stage that is starting an internal process on the retired controller stored data, regarding transferring the data for each of the selected controller LUNs to a newly selected controller allocation for each LUN that resides on the about to be retired controller. Step 358 is an internal lower level hierarchy sub-loop activation stage that is starting an internal sub-process on the retired controller stored data, regarding transferring the data for each of the selected controller data Blocks to a newly selected controller allocation for each data block that resides on the about to be retired controller. After selecting a specific data Block the MDS at step 360 will flag to itself not to accept new layout requests for the selected block. As a result, clients (203) that try to get a layout to that particular byte range from step 362 and until step 372 will get a Retry response. The next step 362 is related to the MDS system sending an instruction to return the layout once given (CB_LAYOUTRECALL). This is sent to clients with a relevant layout copy, which are layout recall messages to all the system clients that have or use layouts in the about to be retired controller, or alternatively the system sends this message to all the system clients. The following step is related to the system itself, or through the system administrator pre-process manual instruction to the system, is setting up a lease time clock that defines the maximal time duration that the system will wait for all the addressed clients' response related to the CB_LAYOUTRECALL request issued in step 362.

Decision making step 368 is initiated by the previous step 364 that issued to all the system's clients a request to check if they are using the relevant matching layout. If there is no matching layout feedback response received by the system, then the relevant data Block selected in step 358 is migrated by the system in step 370 to a LUN on a selected replacement controller that are selected by the system to replace the old retiring controller. Alternatively if there is a positive acknowledge with a matching layout response coming from a client, then step 366 is initiated which represents executing a waiting delay, created as defined in step 364, generated for waiting for the addressed client feedback response during the lease time generated by the 364 time clock, until a client LAYOUTRETURN is received by the system, or the lease-time waiting time delay is expiring during which no LAYOUTRETURN client's feedback has been received. At this stage step 370 is triggered and the relevant selected Block of data is removed by the system and extracted from the old controller LUN to a new LUN on another newly selected replacement storage controller.

To summarize, the old controller retirement downscaled process represented by the set of steps 360,362,364,366 and 370 represent the entire proposed sequence of steps of transmitting under the present invention method the old controller data to a newly selected replacement storage controller, all related to a selected data Block residing on a selected LUN that is residing on the retired storage controller.

Step 372 is another decision making stage for checking if there are more relevant data Blocks in the retiring controller that need to be migrated to the new controller, if there is another relevant data block the system returns to step 358 and starts a new Block status evaluation process and migration cycle, done by executing another cycle of the steps 360,362,364,366 and 370. This cycle loop is repeated until all the data Blocks were migrated from the old to be retired controller to the group of newly selected controllers. When the last Block in the selected LUN was detected and migrated to a newly selected controller, or to a plurality of newly selected controllers, the system then starts to evaluate in the decision step 376. If there is a still new relevant Block to be migrated from the retiring storage controller it returns to step 358. If not, the system is moving to decision step 376.

Decision step 376 checks if there are additional LUNs in the retiring controller to be evaluated for their data content to be transferred from the old retiring controller to one or more newly selected controllers. If there are additional LUNs to be checked for their data content transfer, then a loop action under transition arrow trigger 361 indicating an additional cycle is initiated, where the process returns to 356 to start and repeat again the content evaluation and data transfer process for the entire next evaluated LUN in the about to be retired controller. When all the LUNs in the retired controller have been already evaluated by the system and their data content has been transferred to newly selected controllers the decision step 376 is at this stage indicating the stage wherein the system has ended the selected retiring controller retiring process as stated in the final stage 336. At that stage the pNFS MDS system considers the old retiring controller to be detached and sends notification to the Storage Administrator for retired controller shutdown process finalization.

Referring now to FIG. 3C, as an optional system clients' oriented operational safety add-on level to this retirement process method, an optional process loop containing the stages 332 and 334 may be executed. This optional stage is sending the controller deletion notification to each one of the system clients to let them know that the selected retired server is no more under operation and all its LUNs are void of relevant data for their applications. This loop is optional since in any case the MDS server of the pNFS system has all the required updated address data related to the new controller data content and data organization, so that the clients will be able to access directly and with no further interruptions the new related layouts required for their applications that are at this stage all resident in the newly selected and relevant data updated controller.

The above method steps for moving the entire data content and its transfer process from an old to be retired controller to a newly selected controller under the pNFS system management enables a very short and efficient storage controller aging cycle when compared to the present art legacy NFS systems controller's much longer time duration related retirement process.

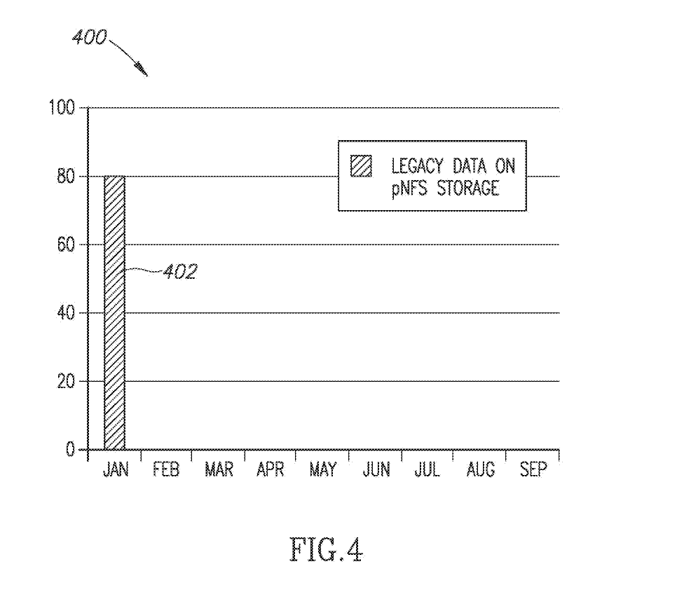

Reference is now made to FIG. 4, which is an illustration of an example of a utilization graph 400 of an exemplary present art pNFS storage system with an under-utilized data storage controller which is in the process of retiring by the system administrator. In this embodiment it is possible to perform the entire migration in a typical short time duration, which is in a matter of hours to several days, consequently all the selected controller retiring process will be completed within less than a month. Migrating data from a storage controller that has data that runs under pNFS storage may be considered very efficient and very short time consuming. In this case we may substantially shorten the period of time under which the controller fades out, when compared to the present art known retiring process, typically set by the used capacity in the controller and the network load, which the administrator is willing to tolerate. This highly efficient short time consuming process of controller's capacity usage versus time is illustrated in the FIG. 4 graph, wherein the gray bar 402 represents the selected controller's pNFS data in percents data storage capacity versus time. For starting the retirement process the systems pNFS MDS starts a very fast chunk by chunk data transfer process from the old to be retired data controller to newly selected data controllers. This process is highly parallelizable and is kept on until finally the data storage controller is effectively void of data and ready to be shut down by the administrator. In a typical downtime period required for the solely pNFS data storage embodiment case, the controller retiring process phase maybe executed within a typical time duration in the matter of several days, or less.

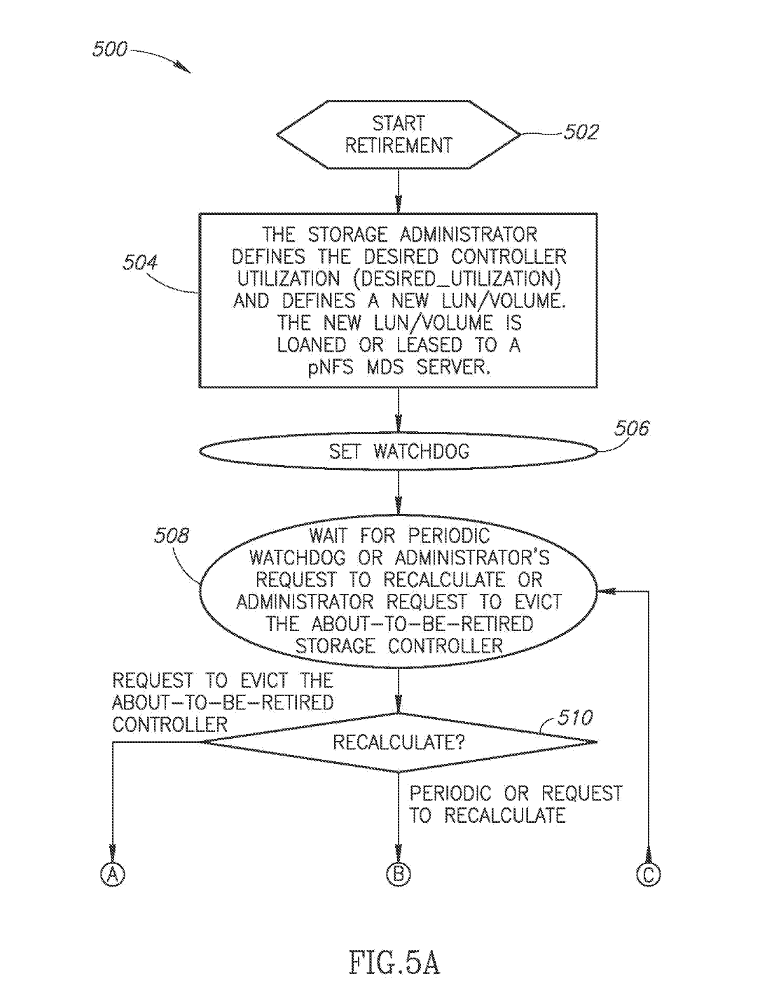

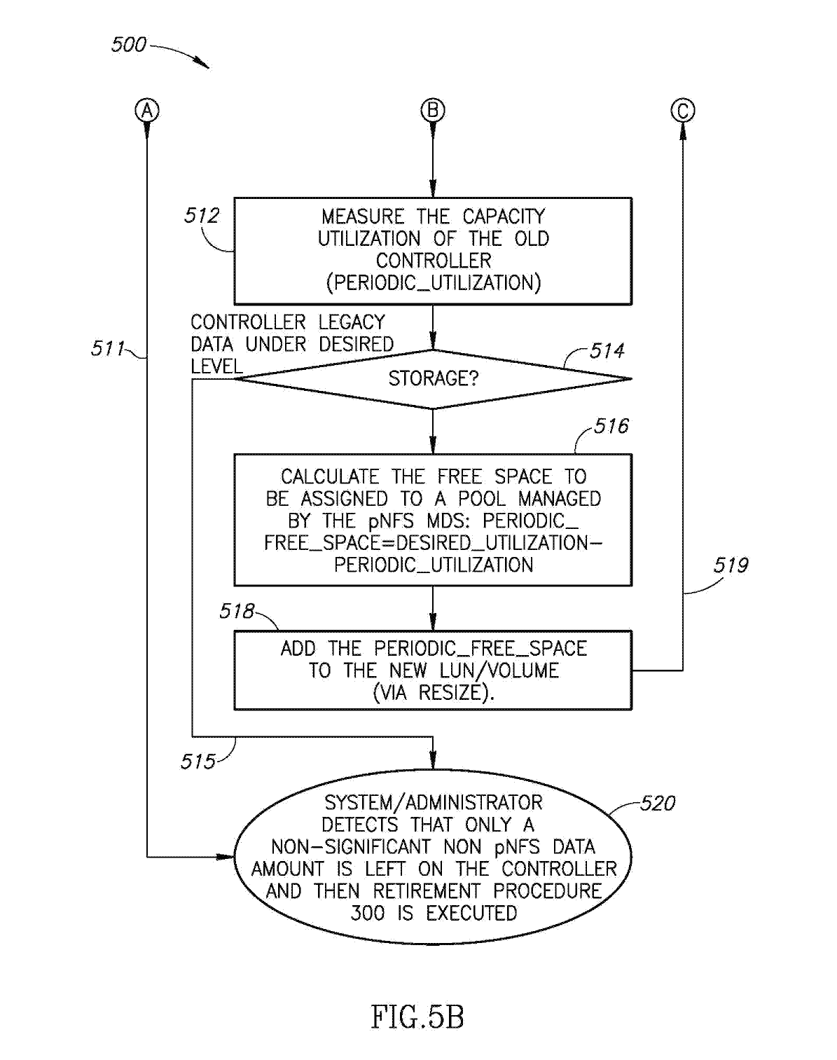

Reference is now made to FIG. 5, which is a schematic illustration of a method running under a flowchart representing a state machine wherein states reflect actions and transition arrows relate to internal or external triggers, which are performed with regard to a certain layout, according to another embodiment of the present invention, wherein migrating data from a storage controller that has data that is not run under pNFS storage may be considered harder, complicated and highly time consuming. In this embodiment the storage utilization during the retirement period combines both legacy non-pNFS storage, as well as new temporary pNFS partial data storage space use on the same about to be retired controller. In this embodiment we may not shorten the period of time in which the controller fades out and retires, but alternatively focus on improving the old controller storage capacity utilization during the entire time period that is required for the process of retiring the old controller by the system administrator.

FIGS. 5A-5B is a flowchart 500 of a state machine describing a method for efficiently retiring a storage controller containing legacy non-pNFS data by running it under pNFS storage of a parallel access network file system, such as the system depicted in FIG. 2, according to some embodiments of the present invention. In use, as shown at flowchart 500, a typical pNFS architecture parallel access storage system 200 administrator, decides at the initial stage 502 to start a retirement process of one of the system data storage controllers (202), typically the retirement is initiated due to the selected controller aging, or due to the retiring controller associated technical operational malfunctioning problems. The first controller retirement method step 504 is associated with the storage administrator defining the desired controller utilization goal parameter (Desired_utilization) during the retirement process period. The Desired_utilization is a parameter which is the total data storage effective and dynamic storage capacity, in data capacity percents, relative to the controller maximum storage capacity. The Desired_utilization parameter is achieved by combining both the old legacy effective data storage capacity of the retiring controller, combined together with the new temporary pNFS data storage capacity that the system will save on the retiring controller during the retirement period. The system administrator is also defining in step 504 a new LUN or a new Volume, to reside within the retiring controller storage space, wherein the new LUN, or Volume, is loaned or leased to a pNFS MDS server which is a part of the system. The selection of a new LUN is related to the case that the retiring controller is a SAN block level data storage controller and the selection of a new Volume is related to the case wherein the retiring controller is a NAS file level data storage controller.

The following step 506 in the present invention another embodiment method of a controller retirement procedure, is a step which is related to setting up a periodically activated watchdog procedure for the system to dynamically monitor the controller data storage utilization efficiency. This would typically be set for a month or more often. Step 508 is a system instruction to wait for the next Periodic watchdog instruction, or for the administrator's request to recalculate the controller's dynamically changing present total storage effective data storage capacity, or respond to the system administrator request to evict the about-to-be-retired storage controller. Step 510 is a decision making step, in which the system needs either to re-calculate the present dynamically changing capacity utilization of the controller under a calculation sequence starting in the following step 512, or to evict the retiring controller and enter into stage 520, in which the controller is ready for either shutting down after the system goes through process 300, or for using controller as a pNFS DS (202). The re-calculation option in decision step 510 can be initiated periodically or by an administrator specific request to recalculate.

Step 512 starts the calculation sequence by measuring the present state, dynamically changing, old legacy non-pNFS data storage capacity utilization of the old to be retired controller, defined as (Periodic_utilization). The following step is a decision step 514, wherein the system decides, based on the measured amount of old legacy data results of step 512, if either to end the controller utilization when the controller legacy data content is reaching the state of containing only a residual old data content percentage under a predefined final controller retirement process initiation based on the maximum allowed old legacy non-pNFS data storage capacity level and then choose the path 515 leading to the final stage 520. Alternatively if the old non-pNFS data content in the retiring controller is still above the predefined maximum allowed residual non-pNFS data content in the retiring controller, then the system continues to the following calculation step 516.

According to one embodiment, the system asks the administrator how to continue if the old non-pNFS data content in the retiring controller is still above the predefined maximum allowed residual non-pNFS data content in the retiring controller, but there is no progress in reducing the old non-pNFS data. In step 516 the system calculates the periodic free space to be assigned to a pool managed by the pNFS MDS under the calculation procedure defined as: Periodic_free_space=Desired_utilization−Periodic_utilization. The calculated results of the step 516 procedure are then used in the following step 518 wherein the system adds the calculated Periodic_free_space data capacity results as a pNFS resource, typically as a resize operation to the LUN/Volume created in step 504. The next step in this process following the calculation of the Periodic_free_space results, is done by closing a loop 519 back to step 508 where the system starts, after a watchdog scheduled time delay (or asynchronous administrator request), another cycle of evaluating if the newly then measured Periodic_utilization controller data capacity use parameter is still over the minimum amount of non-pNFS data level, or not.

When after a sequence of consecutive Periodic_utilization calculation cycles the system is reaching a low enough Periodic_utilization old non-pNFS data storage capacity utilization amount result, only then the system is reaching through stage 514 and transition arrow trigger 515, the final stage 520. At this stage the system automatically detects, or alternatively the system Administrator manually detects, that the retiring controller data storage capacity is at that stage only has a non-significant non-pNFS amount of stored old legacy non-pNFS amount of data is left on the controller, while in parallel mostly pNFS temporary data is residing on the controller, then at this stage the retirement comparatively short duration procedure 300 is executed by the system. By the end of procedure 300 the controller is effectively void of usable data and is then shut down, either automatically by the system itself, or manually by the system administrator. According to one embodiment the administrator can also decide to keep the controller active in its new format, a 100% pNFS DS (202).

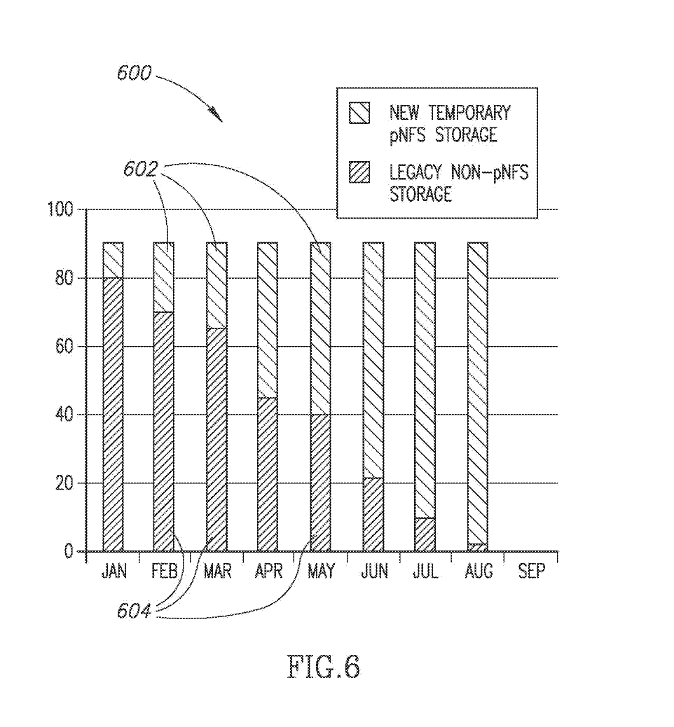

Reference is now made to FIG. 6 which is an illustration of an example utilization graph 600 of an exemplary another embodiment of the present invention, wherein migrating legacy data from an under-utilized data controller in the process of retiring by the system administrator, while referring to the case that data is not run under pNFS storage and consequently this process is more complicated and time consuming. In this case we may not shorten the period of time in which the controller fades out, but alternatively focus on improving the old controller utilization during the downtime period. Under this embodiment specific example the administrator has started the process in January and the data storage controller was kept alive for 9 months. In parallel during this period the non-pNFS data storage capacity and the related utilization percentage of the storage controller dark area of graph bars 602 is gradually going down, while in parallel the temporarily lent/leased to a pNFS MDS data storage capacity and the related pNFS MDS data utilization percentage of the storage controller is going up in order to continously maintain the storage controller maximum data storage capacity. The dark bars 602 in FIG. 6 represent the non-pNFS data (similar behavior to the one presented in FIG. 1) and the grey bars 604 represent growing capacity portions that are temporarily lent/leased to a pNFS MDS that supports storage virtualization.

The present embodiment typical utilization graph 600 demonstrates that during all this period the non-pNFS data storage capacity and the related utilization percentage 602 of the storage controller is gradually going down, while temporarily lent/leased to a pNFS MDS data storage capacity and the related pNFS MDS data utilization percentage of the storage controller capacity 604 is going up, synchronized by pNFS MDS the in a way required to ensure the continuous maintenance the retiring controller maximum storage use capacity during the entire retirement process, until the storage controller is fully containing only temporarily lent/leased pNFS MDS data. At that stage the administrator can start a short time duration second phase in the controller retiring process that is described in the first present invention embodiment method of FIG. 3. At this stage the systems starts the fast chunk by chunk data transfer process from the old to be retired data controller to the newly selected data controller, this process is kept on until finally the data storage controller is void of stored data and ready to be shut down by the administrator. The additional downtime period required for the second data controller retiring process phase is typically in the matter of up to several days.

While the invention has been described with respect to a limited number of embodiments, it will be appreciated by persons skilled in the art that the present invention is not limited by what has been particularly shown and described herein. Rather the scope of the present invention includes both combinations and sub-combinations of the various features described herein, as well as variations and modifications which would occur to persons skilled in the art upon reading the specification and which are not in the prior art.

1. A computerized method for managing the data objects and layout data stored in an at least one first storage device of a parallel access network system having a meta data server managing said layout data and the transfer of said data objects to an at least one second storage device operating under said parallel access network system comprising a sequence of steps for optimal storage capacity management and use of said at least one first storage device during the time period associated with said data objects transfer from said at least one first storage device to said at least one second storage device, wherein said data associated with the at least one first storage devices is not managed under said meta data server, the method comprising the steps of:
defining the desired storage capacity utilization parameter goal of at least one first storage device selected from the group of options including defining said parameter by the system storage administrator and defining said parameter by a system default option;
assigning a new group of layout data related to said at least one first storage device to be loaned or leased to said system meta data server
recalculating the periodic utilization storage capacity of said at least one first storage device by measuring the periodic utilization representing the capacity utilization of said at least one first storage device;
calculating a periodic free space parameter to be assigned to a layout pool managed by said meta data server wherein said storage periodic free space=said storage desired storage utilization—said storage periodic utilization;
adding said storage calculated periodic free space to the assigned size of said group of layouts while resizing said group of layouts;
repeating the sequence of recalculating the group periodic utilization storage capacity said a least one first storage device; and
ending the recalculation process when said system administrator detects that only a non-significant amount of said object data and associated layouts which are not managed under said meta data server associated with said at least one first storage device is left on said at least one first storage device.

2. The computerized method of claim 1, further comprising the step of;
waiting for a periodic watchdog prior to recalculating the periodic utilization storage capacity of said at least one first storage device.

3. The computerized method of claim 1, further comprising the step of;
executing a retirement procedure for said at least one first storage device at the end of said sequence of steps.

4. The computerized method of claim 3, wherein said retirement procedure comprises the steps of:
extracting the layouts associated with said at least one first storage device from their new allocation options to avoid its further usage for said system new applications by any of the plurality of said system clients;
blocking new layout requests for any group of selected layouts associated with said at least one first storage device;
issuing a layout recall request to a plurality of clients sharing relevant layout copies in said group of selected access data;
waiting for up to a predefined lease time to get from said clients a layout return feedback notice concerning sharing a matching layout;
receiving layout return acknowledge responses from said plurality of clients;
migrating the object data associated with said group of selected layouts from said at least one first storage device to a newly selected plurality of storage devices; and
repeating the sequence of object data transfer steps from said at least one first storage device to said at least one second storage device until all data content of the at least one of said first storage device is transferred to said at least one of said second storage devices.

5. The computerized method of claim 1, wherein said parallel access network system having a meta data server is a pNFS network system having a MDS data server.

6. The computerized method of claim 5, wherein said at least one of said first and second storage devices comprises NAS File level type storage data servers.

7. The computerized method of claim 5, wherein said at least one of said first and second storage devices comprises SAN Block level type storage data servers.

8. The computerized method of claim 4, wherein said parallel access network system having a meta data server is a pNFS network system having a MDS data server.

9. The computerized method of claim 8, wherein said at least one first and second storage devices comprises NAS File level type storage data servers.

10. The computerized method of claim 8, wherein said at least one first and second storage devices comprises SAN Block level type storage data servers.

11. A parallel access network file system, comprising:
a metadata server storing and managing layout data;
a plurality of clients sharing said system;
at least one first storage device storing data objects and layouts;
at least one second storage device; and
wherein said system executes a retirement procedure for said at least one first storage device under a sequence of steps intended for optimal storage capacity management and use of said at least one first storage device during the time period associated with said retirement procedure wherein said data objects are gradually transferred from said at least one first storage device to said at least one second storage device, and wherein said data stored in said at least one first storage device is not managed under said meta data server.

12. The system of claim 11, wherein said layouts stored in are loaned or leased during said procedure to said meta data server storing and managing layout data.

13. The system of claim 12, wherein said optimal storage capacity management and use first storage device is executed said metadata server is using said leased layouts to temporary store in said at least one first storage device additional leased data objects.

14. The system of claim 13, wherein said metadata server is storing said leased data objects so that the sum of the gradually diminishing number of said originally stored data objects on said at least one first storage device with said temporarily leased data objects is kept practically constant while maintaining said at least one first storage device data storage capacity to its optimal storage level defined by one of a group including the system administrator and the system default parameter.

15. The system of claim 11, wherein said parallel access network file system is a pNFS network system having a MDS data server.

16. The system of claim 11, wherein said at least one first storage device is a NAS server and said stored data objects and layouts are Files and Volumes.

17. The system of claim 11, wherein said at least one first storage device is a NAS server and said stored data objects and layouts are Blocks and LUNS.

18. A computer program product for executing a retirement procedure for a plurality of storage devices retirement procedure in a parallel access network file system comprising a metadata server storing and managing layout data, a plurality of clients sharing said system, at least one first storage device storing data objects and layouts and at least one second storage device, wherein said retirement procedure for said at least one storage device storing data objects and layouts is executed under a sequence of steps intended for the optimal storage capacity management of said at least one first storage device and use during the time period associated with said retirement procedure wherein said data objects are transferred from said at least one first storage device to said at least one second storage device, and wherein said data stored in said at least one first storage device is not managed under said meta data server, the computer program comprising:
first program instructions to define the desired data storage capacity utilization parameter goal of said at least one first storage device by the system storage administrator;
second program instructions to assign a new group of layout data related to said at least one first storage device to be loaned or leased to said system meta data server
third program instructions to wait for a periodic watchdog prior to recalculating the periodic utilization storage capacity of said at least one first storage device;
forth program instructions for recalculating periodic utilization storage capacity said at least one first storage device by fifth program instructions to measure the Periodic_utilization representing the capacity utilization of plurality of said at least one first storage device;
sixth program instructions to calculate the Periodic_free_space to be assigned to a layout pool managed by said meta data server wherein Periodic_free_space=Desired_utilization−Periodic_utilization;
seventh program instructions to add said calculated Periodic_free_space to the assigned size of said group of layouts via a Resize;
eighth program instructions to repeat the sequence of recalculating the periodic utilization storage capacity said at least one first storage device; and
ninth program instructions to end the sequence of recalculating said at least one first storage device periodic utilization storage capacity when only a non-significant amount of said object data and associated layouts which are not managed under said meta data server associated with the at least one first storage device are left on said at least one first storage device;
wherein said first, second, third, fourth, fifth, sixth, sevenths, eighths and ninths program instructions are stored on said computer readable storage medium.

19. The computer program product of claim 18 for executing a retirement procedure on at least one of said first plurality of storage devices, further comprising a tenth program instruction to execute a retirement procedure for said at least one of said first plurality of storage devices.
